(19) United States
(12) Patent Application Publication
(10) Pub. No.: US 2017/0123442 A1
(43) Pub. Date: May 4, 2017

(54) System and Method of Smart and Energy-Saving Environmental Control

(71) Applicant: INSTITUTE FOR INFORMATION INDUSTRY, Taipei (TW)

(72) Inventors: Tsung-Hsi TSAI, Kaohsiung City (TW); Tsung-Lin WU, Taipei City (TW); Kuo-Hao CHANG, Taipei City (TW); Grace LIN, Hualien County (TW)

(21) Appl. No.: 14/956,374

(22) Filed: Dec. 1, 2015

(30) Foreign Application Priority Data
Oct. 28, 2015 (TW) 104135461

(51) Int. Cl. G05D 23/19; G06F 17/30; G05B 15/02

(52) U.S. Cl. CPC G05D 23/1927; G05D 23/1917; G05B 15/02; G06F 17/30312

(57) ABSTRACT

A method of smart and energy-saving environmental control includes the following steps: collecting a plurality of physiological information and location information of users and environmental information through a plurality of sensors; identifying an active state of each of the users according to the physiological information and the location information, and getting a metabolic rate corresponding to the active state; determining a plurality of weights based on types or levels of the users, and selecting one model from the energy-saving regulation models to serve as a selected model according to the number of the users and the weights; setting an energy-saving regulation value based on the active states, the weights and the selected model; regulating environmental control devices according to the energy-saving regulation value.

### RELATED APPLICATIONS

This application claims priority to Taiwan Application Serial Number 104135461, filed Oct. 28, 2015, which is herein incorporated by reference.

### BACKGROUND

Field of Invention

The invention relates to a controlling technique, and particularly to a system and method of smart and energy-saving environmental control.

Description of Related Art

In existing field domains (e.g., a shopping place), a worker on duty needs to flexibly adjust the temperature set point and air-outlet angle of a air conditioner used in the shopping place, so as to maintain the environmental comfort level of the shopping place. However, the worker often negligently forgets to adjust the temperature set point of the air conditioner, and thus a senseless and power-consumptive phenomenon of overheating or overcooling is caused by the air conditioner used in the shopping place.

Although currently there are various kinds of controlling methods, a model which takes into account the situation where many workers co-exist has not been considered. However, in actual situations generally many workers co-exist in the same field domain. When in the same field domain many people have different preferences or varied states, the existing technique cannot process such cases.

Thus, many in the industry are endeavoring to find ways to effectively solve the aforementioned inconvenience and disadvantages.

### SUMMARY

An aspect of the invention provides a system of smart and energy-saving environmental control, including a plurality of sensors and a mainframe, wherein the mainframe includes a database and a processor. These sensors are used for collecting a plurality of physiological information and location information of users and environmental information. The database is used for storing user information and a plurality of energy-saving regulation models, wherein the user data includes types and levels of the users. The processor performs the following operations: identifying an active state of each of the users according to the physiological information and the location information of these users, and getting a metabolic rate corresponding to the active state; determining a plurality of weights based on types or levels of the users, and selecting one model from the energy-saving regulation models to serve as a selected model according to the number of the users and the weights; setting an energy-saving regulation value based on the active states, the weights and the selected model; regulating a plurality of environmental control devices according to the energy-saving regulation value.

Another aspect of the invention provides a method of smart and energy-saving environmental control, including: collecting a plurality of physiological information and location information of users and environmental information through a plurality of sensors; identifying an active state of each of the users according to the physiological information and the location information, and getting a metabolic rate corresponding to the active state; determining a plurality of weights based on types or levels of the users, and selecting one model from the energy-saving regulation models to serve as a selected model according to the number of the users and the weights; setting an energy-saving regulation value based on the active states, the weights and the selected model; regulating a plurality of environmental control devices according to the energy-saving regulation value.

Through the technique disclosed in the invention, the optimal energy-saving regulation value is found by using an energy-saving regulation optimization model and considering respective states and preferences of multiple users.

In the following embodiments the above general description is described in details and the technical solutions of the invention is further explained.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a block diagram of a system of smart and energy-saving environmental control according to an embodiment of the invention; and

FIG. 2 is a flowchart of a method of smart and energy-saving environmental control according to an embodiment of the invention.

### DETAILED DESCRIPTION

In order to make the description of the invention more detailed and more comprehensive, various embodiments are described below with reference to the accompanying drawings. The same reference numbers are used in the drawings to refer to the same or like elements. Additionally, well-known elements and steps are not described in the embodiments to avoid causing unnecessary limitations to the invention.

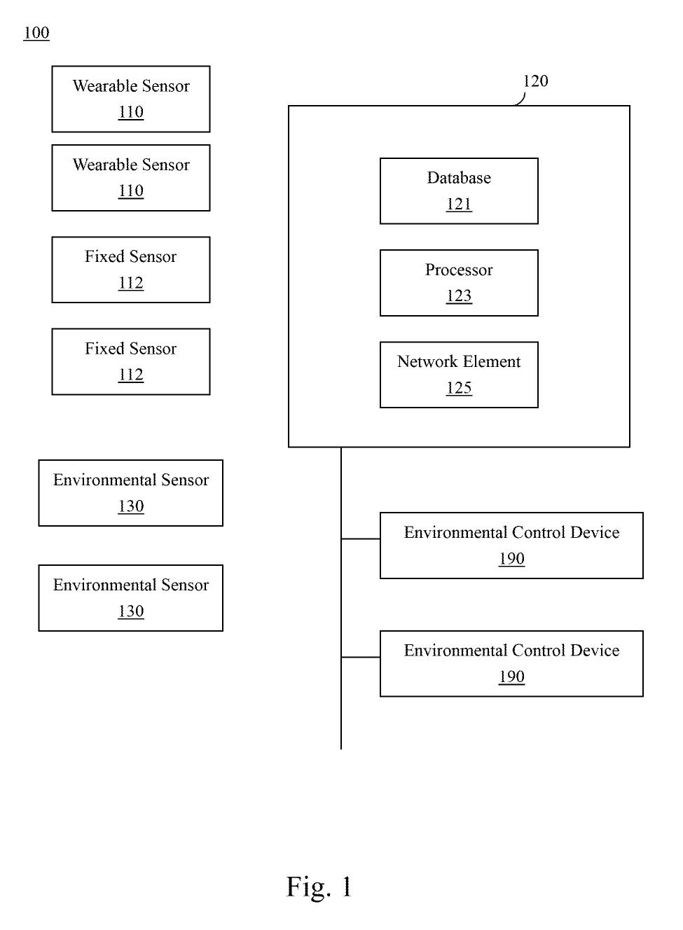

Reference is made to FIG. 1. FIG. 1 is a block diagram of a system 100 of smart and energy-saving environmental control according to an embodiment of the invention. The system 100 of smart and energy-saving environmental control includes a plurality of wearable sensors 110, fixed sensors 112, environmental sensors 130, an environmental control device 190 and a mainframe 120, wherein the mainframe includes a database 121, a processor 123 and a network element 125. In an embodiment, the database 121 may be integrated with a storing device (e.g., a hard disk), and the processor 123 may be a standalone microprocessor or a central processing unit.

The sensors 110 and 112 are used for collecting a plurality of physiological information and location information of users, and the environmental sensor 130 is used for collecting environmental information. The database 121 is used for storing user information and a plurality of energy-saving regulation models, wherein the user information includes types or levels of these users.

The processor 123 is used for performing the following operations: identifying an active state of each of the users according to the physiological information and the location information, and getting a metabolic rate corresponding to the active state; determining a plurality of weights based on types or levels of the users, and selecting one model from the energy-saving regulation models to serve as a selected model according to the number of the users and the weights; setting an energy-saving regulation value based on the active states, the weights and the selected model; regulating a plurality of environmental control devices 190 according to the energy-saving regulation value.

In an embodiment, the database 121 includes a computer program executable by the processor 123, wherein when the computer program is performed by the processor 123, the system 100 of smart and energy-saving environmental control performs the smart and energy-saving environmental control. The smart controlling process of the system 100 of smart and energy-saving environmental control will be described in more details hereafter.

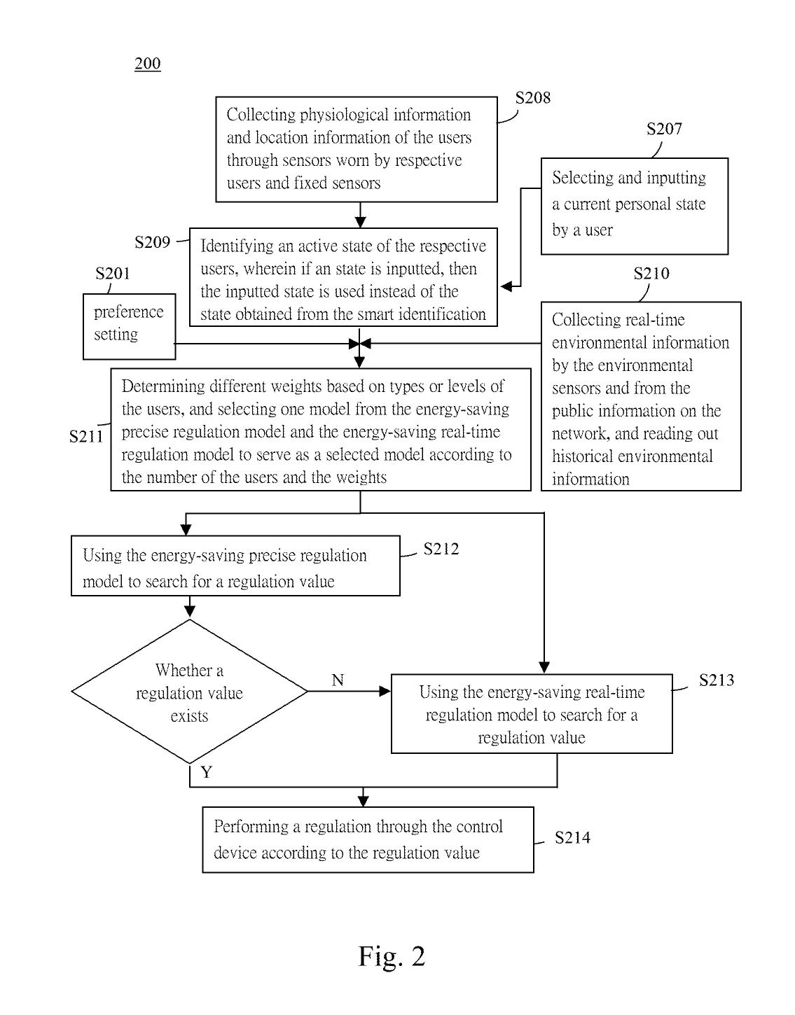

Referring to FIG. 2, it is a flowchart of a method 200 of smart and energy-saving environmental control according to an embodiment of the invention. The method 200 of smart and energy-saving environmental control may be embodied by the system 100 of smart and energy-saving environmental control as shown in FIG. 1, although the invention is not limited to this. For ease and clarity of illustration, it is taken as an example that the method 200 of smart and energy-saving environmental control is embodied by the system 100 of smart and energy-saving environmental control as shown in FIG. 1.

In step S201, a user inputs a preference setting into the system 100 of smart and energy-saving environmental control, and the database 121 stores the preference setting.

In an embodiment, the user input a personal clothing rate according to the clothing condition of the user. If the clothing thickness of the user is relatively thick (e.g., a jacket or overcoat), the information thereof is inputted into the system 100 of smart and energy-saving environmental control, so as to control the environmental control device 190 to reduce the environmental temperature, and vice versa.

In an embodiment, the user inputs a personal cold/hot preference value according to a preference of the user. After the user inputs the settings of cold/hot preference, if the user prefers coolness, then during environmental control the system 100 of smart and energy-saving environmental controls bias to reduce the temperature and decrease the humidity.

In an embodiment, the system 100 of smart and energy-saving environmental control limits the control range according to geographic areas, personal medical records and family medical history of the user and considerations for saving energy. For example in a gym the temperature is set above 20° C., and in a general residence the temperature is set above 24° C. A too low temperature is not allowed for a user with a medical history of hypertension. A preferred temperature lower than 20° C. is inhibited so as to effectively save the energy. Also users with different medical histories have different priorities, wherein for example the cold/hot preference/limit of a cardiac patient is more important than that of a general user (the priority weight of a cardiac patient is higher than that of a general user).

In an embodiment, the system 100 of smart and energy-saving environmental control needs to read out historical metabolic information according to the state of each user, and the processor 123 checks whether historical data is stored in the database 121. If no historical data is stored in the database 121, the processor 123 determines the metabolic rate of the user based on standard metabolism of an adult stored in the database 121. If historical data is stored in the database 121, the processor 123 reads out personal historical metabolism data so as to determine the metabolic rate of the user.

In step S207, the user selects and inputs the current personal state, e.g., a sleeping state, a relaxing state, an acting state, a running state, and the like.

In step S208, a plurality of physiological information and location information of the user is collected through a sensor 110. In an embodiment, the user uses a fixed sensor 112 (e.g., blood pressure instrument, metabolic rate analyzer, and the like) to measure physiological information (e.g., blood pressure, metabolic rate, and the like) at different states, and inputs the collected data into the system such that the identification made by the system at different physiological states is more accurate; and collects physiological information such as a pulse, a body temperature, a breathing frequency and the like, and information about spatial position through a wearable sensor.

In step S209, the processor 123 identifies the active state of the user according to the physiological information and the location information, but if an inputting state of the user is received (step S207), the processor 123 sets the inputting state as the active state of the user.

In an embodiment, the system 100 of smart and energy-saving environmental control performs a smart identification of the user state (including: a sleeping state, a relaxing state, an acting state, a running state and the like) by analyzing the user state, wherein the system 100 of smart and energy-saving environmental control identifies the user state according to the spatial position (e.g., in the bedroom, a public area, a working area, and the like) and physiological data (e.g., body temperature, breathing frequency, pulse and the like) of the user. For example, when the user is in the area of a bedroom bed and has a slightly slow pulse (45-48 beat/min), then the system 100 identifies that the user is in the sleeping state. Additionally if a setting of the user state (step S207) is inputted, then the setting overwrites the state obtained from the smart identification, and thus the state set by the user himself/herself is used instead.

In step S210, real-time environmental information is collected by the environmental sensor 130 and from the public information on the network, and the historical environmental information stored in the database 121 is read out. In an embodiment, the real-time data of environmental factors collected by the environmental sensor 130 are mainly data of indoor environment, and data of other environmental factors collected by the processor 123 through the network element 125 (e.g., a network card) from the public data on the network is mainly data of outdoor environment.

In step S211, the processor 123 identifies the active state of each of the users according to the physiological information and location information of the users, and gets the metabolic rate corresponding to the active state; determines a plurality of weights based on types or levels of the users, and selecting one model from a plurality of energy-saving regulation models to serve as a selected model according to the number of the users and the weights. In an embodiment, based on family medical histories and medical information, the system 100 of smart and energy-saving environmental control determines that a user suffered from cardiac diseases or stroke has a high weight; a user with a history of asthma has a medium weight; and a general user has a low weight.

In an embodiment, the system 100 of smart and energy-saving environmental control collects the aforementioned environmental information (including the indoor temperature, outdoor temperature, humidity, wind speed, radiant temperature, and the like), and the metabolic rate and preference settings (e.g., clothing thickness, cold/hot preference) of the user; and subsequently the system 100 put the active state, the metabolic rate, the environmental information, the preference settings, and the types or levels of the users into the selected model to perform a calculation. In an embodiment, the selected model finds the optimal energy-saving regulation value assuming that the thermal comfort degree and light comfort degree of multiple users are satisfied.

In an embodiment, the selected model (regulation model) calculates the comfort degree through an equation of predicted mean vote (PMV). PMV is adopted as an indicator of thermal comfort degree since it shows a comfort range capable of differencing whether it is comfort or not. The PMV function needs six information inputs, wherein two of the inputs are human factors, including the metabolic rate and the thermal resistance of the clothing; and the other inputs are environmental factors, including the indoor temperature, the mean radiant temperature, the relative air flow rate and the relative humidity. For example, the PMV is in a range of −3 to +3, wherein generally the range from −1 to +1 is defined as comfort. Indicators of PMV may be as shown in the table 1 below:

TABLE 1

| | |
|---|---|
| Hot | +3 |
| Warm | +2 |
| Slight Warm | +1 |
| Comfort | 0 |
| Slight Cool | −1 |
| Cool | −2 |
| Cold | −3 |

The PMV function is described as the following relational expressions (1)-(5):

PMV=(0.028+0.3033e^{-0036M})×[M−3.05×(5.733−0.00699M−P)−0.42×(M−58.15)−0.0173M(5.867−P)−0.0014M(34−T)−3.96×10⁻⁸f_{cl}×((T_{cl}+237)⁴−(T_{cl}+237)⁴)−f_{cl}×h_{c}(T_{cl}−T)] (1)

T_{cl}=35.7−0.028M−0.155I_{cl}(3.96×10⁻⁸)f_{cl}×((T_{cl}+273)⁴−(T_{cl}+273)⁴)−f_{cl}h_{c}×(T_{cl}−T)] (2)

if 2.38(T_{cl}−T)^{0.25}≧12.1\sqrt{v}, h_{c}=2.38(T_{cl}−T)^{0.25}; if 2.38(T_{cl}−T)^{0.25}≦12.1\sqrt{v}, h_{c}=12.1\sqrt{v} (3)

if f_{cl}≧0.5032, f_{cl}=1+0.2I_{cl}; if f_{cl}≦0.5032, f_{cl}=1.05+0.15I_{cl} (4)

P=P_{S}RH/100 (5)

T is the indoor temperature (° C.), and Tₘᵣₜ is the mean radiant temperature (° C.). P is the vapor pressure in the air (Pascal), and M is the metabolic rate (W/m³). v is the relative air flow rate (m/s); I_{cl} is the thermal resistance of the clothing (1 clo=0.155 m² K/W), h_{c} is a convective heat transfer factor (W/m² K); f_{cl} is a ratio of clothing surface area; T_{cl} is the temperature of outer surface of the clothing; RH is the relative humidity; P_{S} is a saturated vapor pressure at a specific temperature; and the PMV indicator function may be written as the equation (6) below:

PMV=f(T,Tₘᵣₜ,M,I_{cl},RH,v) (6)

The PMV indicator function is a nonlinear function which is associated with relational expressions (2)-(5). Due to the limitation caused by the relational expressions (2)-(5), it takes some time for calculating the PMV indicator function value, and thus it needs to use nonlinear programming to find the energy-saving regulation value (optimal value). In an embodiment, the solution of the nonlinear programming can be obtained by using Nelder-Mead and Artificial Bee Colony algorithms, although the invention is not limited to this.

In an embodiment, the multiple energy-saving regulation models stored in the database 121 are at least divided into two modes, one being the energy-saving precise regulation model (step S212) enabling individual comfort degrees to be all within an appropriate range; and the other being the energy-saving real-time regulation model (step S213) for reducing the calculation time.

In an embodiment, the energy-saving precise regulation model is described as the relational expressions below:

Minimize L_{θt}+L_{θl}

Subject to |PMVᵢ+ρᵢ|≦kᵢ

Iₘᵢₙ≦Eᵢ≦Iₘₐₓ

θt is an environmental decision-making, including vectors of temperature, humidity, and the wind direction; and θₗ is another environmental decision-making, including the number and illuminance of lamplights in a space. L_{θt} represents the energy consumed under the decision and regulation of θt; and L_{θl} represents the energy consumed under the decision and regulation of PMVᵢ is an individual indicator of thermal comfort degree; ρᵢ is an individual preference of the user; and kᵢ is a comfort region of users with different weights. Iₘᵢₙ and Iₘₐₓ represents the light comfort degree of the users, and Eᵢ is the illuminance at the user position.

In an embodiment, for the energy consumed under the decision of environmental control (including the temperature, humidity, wind speed and illuminance), L_{θt} is the energy consumed by a central air-conditioner, and L_{θl} is the energy consumed by an illumination facility. “Minimize L_{θt}+L_{θl}” is directed to finding a regulation value when the light and thermal comfort degrees are within a comfort range and the consumed energy is the lowest.

In an embodiment, “|PMVᵢ+ρᵢ|≦kᵢ” is directed to limiting the thermal comfort degree and preference of each user to a comfort region, wherein the comfort region varies according to the weights of the users.

In an embodiment, “Iₘᵢₙ≦EᵢλIₘₐₓ” is directed to limiting the light comfort degree and preference of each user to a comfort region, wherein the comfort region varies according to the user states.

“energy-saving precise regulation model” can make all users in the field domain feel comfort, but may increase the calculation time. In practical, the general comfort degree region of the users are calculated and adjusted according to weights and preferences of different users. For example, based on family medical histories and medical information, a user suffered from cardiac diseases or stroke has a high weight; a user with a history of asthma has a medium weight; and a general user has a low weight. When the user has the higher weight, the kᵢ of the model is smaller, and vice versa; and for example the comfort region of a user suffered from cardiac diseases is 1, while the comfort region of a general user is 2. In practical operations, the general comfort degree of all users in the field domain may be considered, but possibly such a regulation value cannot be found. If there is no optimal regulation value, “energy-saving real-time regulation model” is selected for calculation.

In an embodiment, the energy-saving real-time regulation model is described as the relational expressions below:

Minimize L_{θt}+L_{θi}

Subject to E(|PMV|)≦Eₖ+ρ_{E}

Var(|PMV|)≦Vₖ+ρᵥ

Iₘᵢₙ≦Eᵢ≦Iₘₐₓ

θt is an environmental decision-making, including vectors of temperature, humidity, and the wind direction; and θₗ is another environmental decision-making, including the number and illuminance of lamplights in a space. L_{θt} represents the energy consumed under the decision and regulation of θt; and L_{θl} represents the energy consumed under the decision and regulation of θₗ. PMV is an indicator of the general thermal comfort degree. Eₖ represents a comfort-degree region within which the mean comfort degree should be limited; and Vₖ represents a comfort-degree region within which the comfort-degree variance should be limited. ρ_{E} and ρᵥ are general preference of all users.

In an embodiment, “E(|PMV|)≦Eₖ+ρ_{E}” and “Var(|PMV|)≦Vₖ+ρᵥ” is directed to limiting the general thermal comfort degree of all users according to the general preference and the number of users; and accelerating the calculation speed by using a mean value and a variance value, i.e., assuming that most of the users are within the comfort-degree region and the variance is not too large.

“energy-saving real-time regulation model” can accelerate the calculation speed, so as to achieve the real-time regulation. In practical, the mean comfort degree and comfort-degree variance of all users are calculated and different range limitations are given according to the number of users in the space. For example, when the number of users is small (e.g., less than ten), the limitation range of the mean comfort degree and comfort-degree variance is strict (Eₖ=1, Vₖ=1.5); and when the number of users is large (e.g., greater than ten), the limitation to the mean comfort degree and comfort-degree variance is loose (Eₖ=1.5, Vₖ=1.5). As such, the “energy-saving real-time regulation model” can accelerate the finding of the regulation value, but possibly a small number of users may be within an uncomfortable state.

In step S212, when any of different weights corresponding to multiple users is above a threshold value, the processor 123 selects the energy-saving precise regulation model to serve as a selected model of the aforementioned models, wherein the threshold value may be determined by the system designer or from the analysis by the computer. As such, a field domain in which a user with a high weight exists (e.g., a hypertensive patient) can select to use the energy-saving precise regulation model. The energy-saving precise regulation model is used in the situation where individual comfort degrees of these users are considered.

In an embodiment, the energy consumed by the energy-saving precise regulation model under the decision of environmental control (including the temperature, humidity, wind speed and illuminance) includes the energy consumed by the central air-conditioner and the energy consumed by the illumination facility. The energy-saving precise regulation model limits the thermal comfort degree and preference of each user to a comfort-degree region, and the comfort-degree region varies according to the weights of the users, so as to further limit the light and thermal comfort degrees of each user to a comfort region, and the comfort-degree region varies according to the weights of the users.

In an embodiment, the processor 123 performs a nonlinear programming based on the physiological information, the environmental information and the energy-saving precise regulation model, so as to find the energy-saving regulation value (the optimal value). In an embodiment, the solution of the nonlinear programming can be obtained by using Nelder-Mead and Artificial Bee Colony algorithms, although the invention is not limited to this. If the nonlinear programming cannot find the optimal value, then the method proceeds to step S213, in which the parameters are put into the energy-saving real-time regulation model.

In step S213, when the location information of multiple users meets a predetermined condition of frequent moving, then the processor 123 selects the energy-saving real-time regulation model to serve as the selected model, wherein the predetermined condition of frequent moving is determined by the system designer or from the analysis by the computer. As such, in a field domain where multiple users frequently come in and out can select the energy-saving real-time regulation model. The energy-saving real-time regulation model is used in the situation where the mean comfort degree of these users is considered.

In an embodiment, the processor 123 performs a nonlinear programming based on the physiological information, the environmental information and the energy-saving real-time regulation model, so as to find the energy-saving regulation value (the optimal value). In an embodiment, the solution of the nonlinear programming can be obtained by using Nelder-Mead and Artificial Bee Colony algorithms, although the invention is not limited to this.

In step S214, the processor 123 regulates the environmental control device 190 based on the energy-saving regulation value, including the regulation of temperature, humidity and wind speed of an air-conditioning apparatus and the regulation of switching and illuminance of an illumination apparatus, and the like.

With the technique disclosed in the disclosure, a wearable sensor 110 is used for collecting data, wherein the wearable sensor 110 uses a micro electro mechanical system (MEMS) to convert a physical system into messages; the mainframe 120 is connected to the wearable sensor 110 and used for calculation, which identifies the user state at a current phase (e.g., a sleeping state, a relaxing state, an acting state, a running state, and the like) according to data such as a spatial position, a personal habit, a heartbeat and a body temperature; the environmental sensor (e.g., a temperature sensor, a humidity sensor and the like) collects environmental factors (e.g., the temperature, humidity, wind speed, illuminance, concentration of carbon dioxide, and the like); and the wearable sensor 110 (e.g., a medical bracelet, a smart watch and the like) collects physiological factors (the body temperature, heartbeat, breathing frequency and the like), imports the data into the energy-saving regulation model to find the optimal regulation, and searches for an optimal energy-saving regulation decision through algorithms. The system 100 of smart and energy-saving environmental control can be practiced in organizations such as nursing homes and eldercare centers, or practiced in a home embodiment.

The system 100 of smart and energy-saving environmental control analyzes the user states, identifies the behaviors of users according to the states and the spatial positions of the users, and performs regulation according to the behaviors of the users (for example, when the user is just woken up, the state of the user is identified through the movement of spatial positions, body temperature and heartbeat; the system slowly lightens the light sources so as to give the eyes a comfort feel and avoid dazzle; the system also regulates the temperature and humidity of the space to provide a comfortable environment).

The system 100 of smart and energy-saving environmental control provides different regulation settings of the model according to seasons and time. For example, in summer the provided temperature regulation is lower while in winter the temperature regulation is higher; in daytime the controlled illuminance of the lamp is weaker while in the evening the illuminance is stronger; and regulation settings may also be provided as inputted by the users themselves based on different facilities and places.

The system 100 of smart and energy-saving environmental control regulates individual feelings of comfort of the users through the input of additional settings (e.g., personal preferences towards cold or hot), so as to apply the energy-saving regulation model and achieve personalized and humanized settings.

Although the illustrative embodiments of the invention have been described in details in connection with the accompanying drawings, it will be understood that the invention is not limited to these embodiments. Various changes and modifications changes can be made by those of skills in the art, without departing from the scope and spirit of the invention as defined by the appended claims.

What is claimed is:

1. A system of smart and energy-saving environmental control, comprising:
a plurality of sensors for collecting a plurality of physiological information and location information of users and environmental information; and
a mainframe, comprising:
a database for storing user information and a plurality of energy-saving regulation models, wherein the user information includes types or levels of a plurality of users; and
a processor for performing the following operations:
identifying an active state of each of the users according to the physiological information and the location information of the users, and getting a metabolic rate corresponding to the active state;
determining a plurality of weights based on types or levels of the users, and selecting one model from the energy-saving regulation models to serve as a selected model according to the number of the users and the weights;
setting an energy-saving regulation value based on the active states, the weights and the selected model; and
regulating a plurality of environmental control devices according to the energy-saving regulation value.

2. The system of smart and energy-saving environmental control of claim 1, wherein the plurality of sensors comprise a plurality of wearable sensors, a plurality of fixed sensors, and a plurality of environmental sensors.

3. The system of smart and energy-saving environmental control of claim 1, wherein the step of identifying the active state of these users comprises:
if an inputted state is received from a user, then setting the inputted state as the active state of the user.

4. The system of smart and energy-saving environmental control of claim 1, wherein the operations performed by the processor further comprise:
collecting preference settings of the users;
putting the active state, the metabolic rate, the environmental information, the preference settings, and the types or levels of the users into the selected model for calculating.

5. The system of smart and energy-saving environmental control of claim 4, wherein the energy-saving regulation models comprise an energy-saving precise regulation model and an energy-saving real-time regulation model.

6. The system of smart and energy-saving environmental control of claim 4, wherein the step of selecting one model from the energy-saving regulation models to serve as a selected model comprises:
when any of the weights is above a threshold value, selecting the energy-saving precise regulation model to serve as the selected model, wherein the energy-saving precise regulation model is used for analyzing individual comfort degrees of the users.

7. The system of smart and energy-saving environmental control of claim 5, wherein the operations performed by the processor further comprise:
performing nonlinear programming based on the physiological information, the environmental information and the energy-saving precise regulation model, so as to find the energy-saving regulation value.

8. The system of smart and energy-saving environmental control of claim 4, wherein the step of selecting one model from the energy-saving regulation models to serve as a selected model comprises:
when the location information of the users meet a predetermined condition of frequent moving, selecting the energy-saving real-time regulation model to serve as the selected model, wherein the energy-saving real-time regulation model is used for analyzing the mean comfort degree of the users.

9. The system of smart and energy-saving environmental control of claim 8, wherein the operations performed by the processor further comprise:
performing nonlinear programming based on the physiological information, the environmental information and the energy-saving real-time regulation model, so as to find the energy-saving regulation value.

10. A method of smart and energy-saving environmental control, comprising:
collecting a plurality of physiological information and location information of users and environmental information through a plurality of sensors; and
identifying an active state of each of the users according to the physiological information and the location information of the users, and getting a metabolic rate corresponding to the active state;
determining a plurality of weights based on types or levels of the users, and selecting one model from a plurality of energy-saving regulation models to serve as a selected model according to the number of the users and the weights; and
setting an energy-saving regulation value based on the active states, the weights and the selected model; and
regulating a plurality of environmental control devices according to the energy-saving regulation value.

11. The method of smart and energy-saving environmental control of claim 10, wherein the plurality of sensors comprise a plurality of wearable sensors, a plurality of fixed sensors, and a plurality of environmental sensors.

12. The method of smart and energy-saving environmental control of claim 10, wherein the step of identifying the active state of these users comprises:
if an inputted state is received from a user, then setting the inputted state as the active state of the user.

13. The method of smart and energy-saving environmental control of claim 11, further comprising:
collecting preference settings of the users;
putting the active state, the metabolic rate, the environmental information, the preference settings, and the types or levels of the users into the selected model for calculating.

14. The method of smart and energy-saving environmental control of claim 13, wherein the energy-saving regulation models comprise an energy-saving precise regulation model and an energy-saving real-time regulation model.

15. The method of smart and energy-saving environmental control of claim 13, wherein the step of selecting one model from the energy-saving regulation models to serve as a selected model comprises:
when any of the weights is above a threshold value, selecting the energy-saving precise regulation model to serve as the selected model, wherein the energy-saving precise regulation model is used for analyzing individual comfort degrees of the users.

16. The method of smart and energy-saving environmental control of claim 14, further comprising:
performing nonlinear programming based on the physiological information, the environmental information and the energy-saving precise regulation model, so as to find the energy-saving regulation value.

17. The method of smart and energy-saving environmental control of claim 13, wherein the step of selecting one model from the energy-saving regulation models to serve as a selected model comprises:
when the location information of the users meet a predetermined condition of frequent moving, selecting the energy-saving real-time regulation model to serve as the selected model, wherein the energy-saving real-time regulation model is used for analyzing the mean comfort degree of the users.

18. The method of smart and energy-saving environmental control of claim 17, further comprising:
performing nonlinear programming based on the physiological information, the environmental information and the energy-saving real-time regulation model, so as to find the energy-saving regulation value.
